(19) United States
(12) Patent Application Publication
(10) Pub. No.: US 2011/0311253 A1
(43) Pub. Date: Dec. 22, 2011

(54) IMAGE FORMING APPARATUS AND IMAGE FORMATION PROCESSING METHOD

(75) Inventor: Setsuo Takada, Shizuoka-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/164,083

(22) Filed: Jun. 20, 2011

Related U.S. Application Data
(60) Provisional application No. 61/356,889, filed on Jun. 21, 2010.

(51) Int. Cl. G03G 15/20

(52) U.S. Cl. 399/45; 399/67

(57) ABSTRACT

An image forming apparatus with no staining or deterioration of images can be provided. The image forming apparatus includes: an image holding body that transfers toner onto a sheet; a transfer voltage applying unit that applies a transfer voltage for transferring the toner onto the sheet from the image holding body; a fixing unit that includes a heating rotation body which heats the toner on the sheet to fix the toner onto the sheet, and a pressurizing body which forms a nip portion with the heating rotation body and nips and transports the sheet by cooperating with the heating rotation body; a sensor unit that is at a position on an upstream side of the fixing unit in a sheet transport direction and detects an electrical resistance value of the sheet; and a voltage applying unit that applies a predetermined voltage value having the opposite polarity to that of a voltage applied by the transfer voltage applying unit to a reverse surface to a toner transfer surface of the sheet, to the pressurizing body, on the basis of the electrical resistance value of the sheet detected by the sensor unit.

### CROSS-REFERENCE TO RELATED APPLICATION

This application is based upon and claims the benefit of priority from U.S. provisional application 61/356,889, filed on Jun. 21, 2010; the entire contents of which are incorporated herein by reference.

### FIELD

Embodiments described herein relate generally to an image formation processing method in an image forming apparatus.

### BACKGROUND

Hitherto, in an image forming apparatus such as an MFP (Multi Function Peripheral), a toner image transferred from a photoconductor is transferred onto a sheet at a secondary transfer position.

For example, when secondary transfer is performed by an intermediate transfer belt, a secondary transfer opposing roller on which the intermediate transfer belt is suspended, and a secondary transfer roller that opposes the secondary transfer opposing roller with the intermediate transfer belt interposed therebetween, the rear side (a reverse surface to a surface where toner is transferred) of a sheet is positively charged by applying a voltage to the secondary transfer roller so as to pull toner that is negatively charged, thereby transferring the toner image onto the sheet from the intermediate transfer belt.

However, according to the related art, since a predetermined voltage is applied regardless of a state or characteristics of a sheet, an amount of positive charge may become excessive. The excessive positive charge is moved to a pressurizing roller on the rear surface side of the sheet in a fixing device, and moreover, is then moved to a fixing belt (or a fixing roller) opposing the pressurizing roller. As a result, there is a problem in that the fixing belt that fixes the toner image is positively charged, and adsorbs negatively charged toner that is not fixed onto the sheet yet from the sheet.

### DESCRIPTION OF THE DRAWINGS

FIG. 1 is a configuration diagram showing the configuration of an image forming apparatus according to an embodiment.

FIG. 2 is an enlarged view of the vicinities of a second transfer position and a fixing process position of the image forming apparatus.

FIG. 3 is a function block diagram of the image forming apparatus of the embodiment.

FIG. 4 is a graph showing a correlation between resistance values and application voltages stored in an application voltage table.

FIG. 5 is a flowchart showing the flow of an image formation process by the image forming apparatus.

### DETAILED DESCRIPTION

According to one aspect, an image forming apparatus includes an image holding body, a transfer voltage applying unit, a fixing unit, a sensor unit, and a voltage applying unit. The image holding body transfers toner onto a sheet. The transfer voltage applying unit applies a transfer voltage for transferring the toner onto the sheet from the image holding body. The fixing unit includes a heating rotation body which heats the toner on the sheet to fix the toner onto the sheet, and a pressurizing body which forms a nip portion with the heating rotation body and nips and transports the sheet by cooperating with the heating rotation body. The sensor unit is at a position on an upstream side of the fixing unit in a sheet transport direction and detects an electrical resistance value of the sheet. The voltage applying unit applies a predetermined voltage value having the opposite polarity to that of a voltage applied by the transfer voltage applying unit to a reverse surface to a toner transfer surface of the sheet, to the pressurizing body, on the basis of the electrical resistance value of the sheet detected by the sensor unit.

### First Embodiment

Hereinafter, a first embodiment will be described with reference to the drawings.

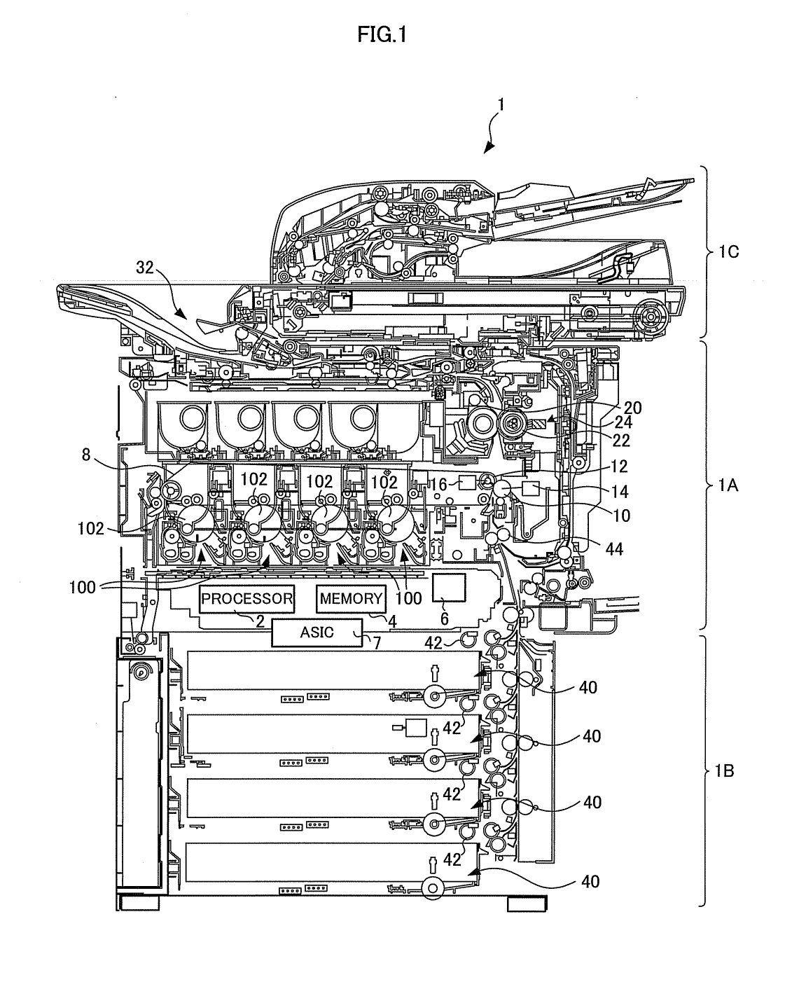

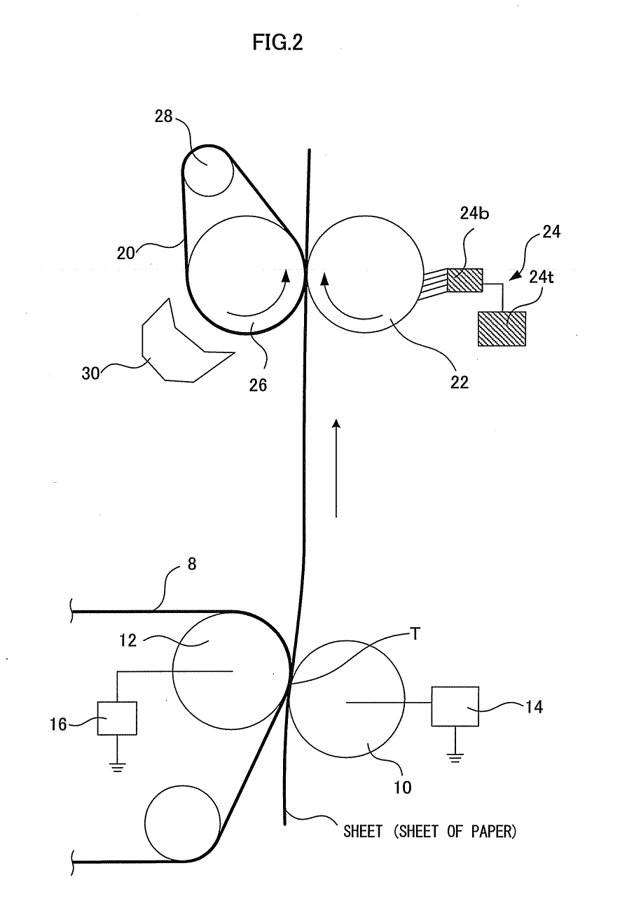

FIG. 1 is a configuration diagram showing the configuration of an image forming apparatus 1 according to this embodiment. FIG. 2 is an enlarged view of the vicinities of a second transfer position and a fixing process position of the image forming apparatus 1.

The image forming apparatus 1 is an MFP (Multi Function Peripheral) which performs printing, copying, scanning, and the like. The image forming apparatus 1 includes an image forming unit 1A, a sheet supply unit 13, an image reading unit 1C, a processor 2, a memory 4, an auxiliary storage device 6, and the like.

First, the image forming unit 1A performs a process of forming an image on a sheet during printing or copying. The image forming unit 1A forms the image on the sheet such as a sheet of paper supplied from the sheet supply unit 1B on the basis of a print job or a copy job.

The image forming unit 1A includes four process units 100 corresponding to yellow, magenta, cyan, and black, respectively, an intermediate transfer belt 8 as an image holding body, a secondary transfer roller 10 which is a transfer member, a secondary transfer opposing roller 12, a bias voltage applying unit 14, a current detecting sensor 16, a paper discharge tray 32, and the like. In addition, the image forming unit 1A includes, as a fixing device, a fixing belt 20, a fixing roller 26, a tension roller 28, an induction heating coil 30, a pressurizing roller 22, and a voltage applying device 24.

First, the four process units 100 form four toner images for yellow, magenta, cyan, and black on the intermediate transfer belt 8, respectively, as described above. Each of the process units 100 includes a photoconductive drum 102, a developing device, a primary transfer roller, and the like.

The toner images formed on the photoconductive drums 102 for their respective colors are overlapped and transferred onto the intermediate transfer belt 8 from the photoconductive drums 102 (primary transfer), such that a single toner image is formed on the intermediate transfer belt 8. In addition, the intermediate transfer belt 8 transfers the formed toner image onto the sheet at a secondary transfer position T.

The secondary transfer roller 10 nips the sheet with the secondary transfer opposing roller 12 opposing with the intermediate transfer belt 8 interposed therebetween, at the secondary transfer position T, so as to transfer the toner image on the intermediate transfer belt 8 onto the transported sheet.

The secondary transfer opposing roller 12 nips the sheet by coming in contact with the secondary transfer roller 10 with the transfer belt interposed therebetween.

The bias voltage applying unit 14 applies a voltage for transferring the toner on the intermediate transfer belt 8 onto the sheet. The bias voltage applying unit 14 applies the voltage to positively charge a surface of the sheet on the secondary transfer roller 10 side, so as to transfer the toner negatively charged on the intermediate transfer belt 8, onto the sheet.

The current detecting sensor 16 which is a sensor that measures characteristics of the sheet measures a current flowing through the secondary transfer roller 10, the sheet as an object of an image formation process, the intermediate transfer belt 8, and the secondary transfer opposing roller 12, using the voltage applied by the bias voltage applying unit 14. The resistance of the sheet such as a sheet of paper passing by the secondary transfer position T can be measured from the voltage applied by the bias voltage applying unit 14 and the measured flowing current. That is, while the bias voltage applying unit 14 applies a constant voltage, from a current value measured in a state where no sheet passes and a current value measured in a state where a sheet passes, the electrical resistance value of the passing sheet can be obtained. Identification of the thickness of a sheet passing or the like can be performed by measuring the resistance value of a medium such as a sheet. Detailed description of a process of calculating the resistance value of a sheet will be provided along with description of a function block of the image forming apparatus 1.

In this embodiment, on the basis of the resistance value of a sheet calculated using a current value detected by the current detecting sensor 16, a voltage applied by the voltage applying device 24 that will be described later is adjusted.

Next, the fixing belt 20 which is a member included in the fixing device fixes the toner transferred onto the sheet onto the sheet at the secondary transfer position T by cooperating with the pressurizing roller 22. Specifically, the fixing belt 20 is heated by the induction heating coil 30, fuses the toner by the heat, and fixes the fused toner onto the sheet by pressure applied by the pressurizing roller 22 which comes in pressing contact with the fixing belt 20.

The fixing roller 26 and the tension roller 28 are rollers on which the fixing belt 20 is suspended. The fixing roller 26 is disposed at a position opposing the pressurizing roller 22 thereby forming a nip portion between the fixing belt 20 and the pressurizing roller 22. The tension roller 28 applies a predetermined tension to the fixing belt 20.

The induction heating coil 30 heats the fixing belt 20 by induction heating. Specifically, the induction heating coil 30 generates a magnetic flux by a current supplied from a power supply (not shown) so that a current is generated by the magnetic flux in a conductive layer of the fixing belt 20 to generate heat, thereby heating the fixing belt 20.

The pressurizing roller 22 is caused to come in pressing contact with the fixing belt 20 by a pressurizing mechanism (not shown) so as to maintain a predetermined nip width with the fixing belt 20 suspended on the opposing fixing roller 26 and nips and transports a sheet P by cooperating with a belt surface of the fixing belt 20.

The voltage applying device 24 applies a voltage to the pressurizing roller 22. Specifically, when a sheet is positively charged by the bias voltage applying unit 14, if the resistance value of the sheet is high and an amount of positive charge becomes excessive and thus positive charge is moved to the pressurizing roller 22 from the sheet, the voltage applying device 24 applies a voltage so as to remove the positive charge. That is, a voltage (in this embodiment, a negative voltage) with the opposite polarity to that of the voltage applied by the bias voltage applying unit 14 to the reverse surface to the surface of the sheet where the toner is transferred is applied to a pressurized body. A process of applying a voltage to the pressurizing roller 22 by the voltage applying device 24 will be described in detail along with the description of the function block that will be described later.

The voltage applying device 24 includes a conductive charging brush portion 24b which comes in contact with the surface of the pressurizing roller 22, and a transforming portion 24t. By a function of controlling the transforming portion 24t described later, the voltage applied to the pressurizing roller 22 by the charging brush portion 24b is adjusted.

To the paper discharge tray 32, the sheet onto which the toner image is fixed by the fixing device is discharged.

The foregoing is the description of the configuration of the image forming unit 1A of this embodiment.

The overview of an image formation process performed by the image forming unit 1A having the above configuration will be described. First, when the image forming apparatus 1 acquires a copy job or a print job, a surface of the photoconductive drum 102 charged by a charger of each of the process units 100 is illuminated with laser beams on the basis of image data of the acquired job, such that an electrostatic latent image is formed. In addition, the developing device supplies toner to the photoconductive drum 102 on which the electrostatic latent image is formed. As the toner is supplied, the electrostatic latent image formed on the photoconductive drum 102 is developed. The photoconductive drum 102 primarily transfers a toner image onto the intermediate transfer belt 8 at a primary transfer position at which the primary transfer roller is disposed. As the intermediate transfer belt 8 is rotated, the toner images for the respective colors are primarily and sequentially transferred by the photoconductive drums 102, such that a toner image corresponding to the image data is formed on the intermediate transfer belt 8. Then, the toner image is secondarily transferred onto the sheet transported from paper feed cassettes 40 at the secondary transfer position T. In addition, the toner image is secondarily transferred onto the sheet from the intermediate transfer belt 8 by the voltage applied by the bias voltage applying unit 14.

The sheet onto which the toner image is transferred is moved to the fixing device. The fixing device heats the toner using the fixing belt 20 and fixes the toner image onto the sheet by the pressure between the fixing belt 20 and the pressurizing roller 22. The sheet onto which the toner image is fixed is discharged to the paper discharge tray 32 through a transport path. The foregoing is the description of the overview of the image formation process by the image forming apparatus 1.

Next, the configuration of the sheet supply unit 1B will be described. The sheet supply unit 1B supplies a sheet to the image forming unit 1A. The sheet supply unit 1B includes the paper feed cassettes 40, pick-up rollers 42, transport rollers 44, and the like. In FIG. 1, the image forming apparatus having four paper feed cassettes 40 and four pick-up rollers 42 is shown.

Each paper feed cassette 40 stores sheets such as sheets of paper for forming images.

Each pick-up roller 42 takes out sheets from the paper feed cassette 40 one by one. The sheet taken out by the pick-up roller 42 is transported toward the secondary transfer position T by other transport rollers disposed on the transport path.

The transport rollers 44 are a pair of rollers that transport the sheet to the secondary transfer position T and are also called registration rollers. The transport rollers 44 are the pair of rollers disposed at the closest position to the upstream side of the sheet transport direction with respect to the secondary transfer position T, from among the rollers disposed on the sheet transport path. The transported sheet strikes the transport rollers 44 which are the stopping registration rollers, such that a position of a front end of the sheet is adjusted. Thereafter, as the transport rollers 44 are rotated, the sheet is transported to the secondary transfer position T.

Next, the image reading unit 1C is a device that reads an image from an original document when copying or scanning is performed and is an image reading device included in a copier, an image scanner, or the like.

Next, the processor 2 is a processing device that controls various processes that may be executed by the image forming unit 1A, the sheet supply unit 1B, the image reading unit 1C, and the like. The processor 2 realizes various functions by executing programs stored in the memory 4 or the auxiliary storage device 6 to perform processes. In this embodiment, particularly, the processor 2 controls operations of the bias voltage applying unit 14, the current detecting sensor 16, the induction heating coil 30, the voltage applying device 24, and the like.

As the processor 2, a CPU (Central Processing Unit), an MPU (Micro Processing Unit) that can execute the same computational processes as those of the CPU, or the like is used. Alternatively, a part or the entirety of the functions of the image forming apparatus 1 realized by the processor 2 may be realized by an ASIC (Application Specific Integrated Circuit) 7 as a processor.

The memory 4 is a so-called main storage device that stores programs that cause the processor 2 to perform the processes such as the image formation process performed in the image forming unit 1A, a sheet supplying process performed in the sheet supply unit 1B, and an image reading process performed in the image reading unit 1C. In addition, the memory 4 provides a temporary job region for the processor 2. As the memory 4, for example, a RAM (Random Access Memory), a ROM (Read Only Memory), a DRAM (Dynamic Random Access Memory), an SRAM (Static Random Access Memory), a VRAM (Video RAM), or a flash memory is used.

The auxiliary storage device 6 stores various kinds of information regarding the image forming apparatus 1. As the auxiliary storage device 6, for example, a magnetic storage device such as a hard disk drive, an optical storage device, a semiconductor storage device (a flash memory or the like), or a combination of such storage devices is used.

The foregoing is the description of the configuration of the image forming apparatus 1 of this embodiment.

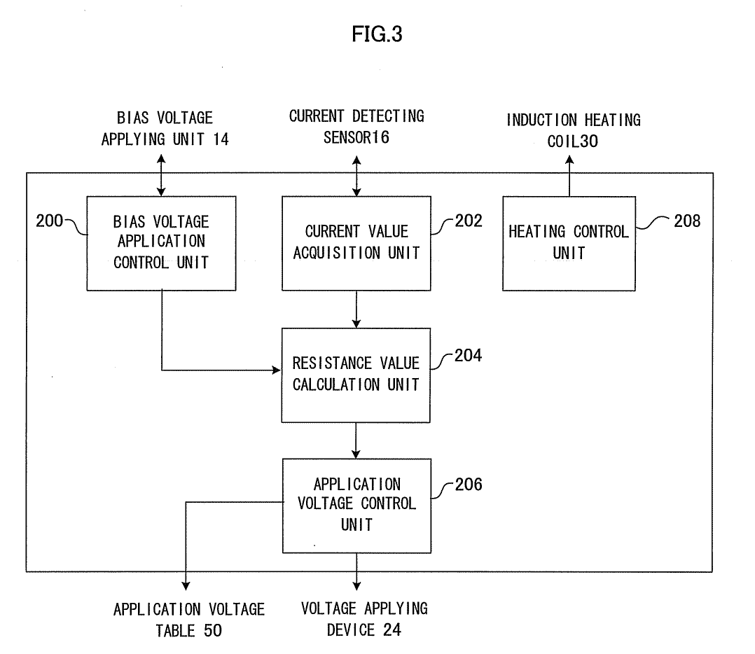

Next, the functions of the image forming apparatus 1 of this embodiment will be described. FIG. 3 is a function block diagram of the image forming apparatus 1 of this embodiment.

The image forming apparatus 1 includes a bias voltage application control unit 200, a current value acquisition unit 202, a resistance value calculation unit 204, an application voltage control unit 206, and a heating control unit 208.

The bias voltage application control unit 200 applies a predetermined voltage between the secondary transfer roller 10 and the secondary transfer opposing roller 12 by controlling the bias voltage application unit 14.

The current value acquisition unit 202 acquires a current value measured by the current detecting sensor 16. The current value acquisition unit 202 acquires a value of current flowing when a sheet passes by the secondary transfer position T and a value of current flowing when no sheet passes by the secondary transfer position T. In addition, whether or not a sheet passes by the secondary transfer position T can be determined by, for example, disposing a sensor that detects the passage of a sheet on the upstream side of the sheet transport direction of the secondary transfer position T, and measuring the values of current flowing when a sheet passes and when no sheet passes on the basis of signals from the sensor indicating whether or not a sheet passes.

As the value of current flowing when no sheet passes, a value measured in every image formation process by the current value acquisition unit 202 may be acquired. If the voltage applied by the bias voltage applying unit 14 is constant, a value of current flowing when no sheet passes may be measured in advance and stored in a storage region of the auxiliary storage device 6 or the like. In this case, the resistance value calculation unit 204 may read the current value from the storage region and obtain the electrical resistance value of the sheet using the read current value.

The resistance value calculation unit 204 calculates the resistance value of the sheet passing by the secondary transfer position T, from a difference between the value of current flowing when the sheet passes by the secondary transfer position T and the value of current flowing when no sheet passes, the values of current being acquired by the current value acquisition unit 202.

The application voltage control unit 206 determines a voltage applied by the voltage applying device 24 on the basis of the resistance value of the sheet calculated by the resistance value calculation unit 204 and applies the voltage using the voltage applying device 24. The application voltage control unit 206 obtains an application voltage corresponding to the resistance value calculated by the resistance value calculation unit 204 with reference to an application voltage table 50 stored in advance in the auxiliary storage device 6 or the memory 4.

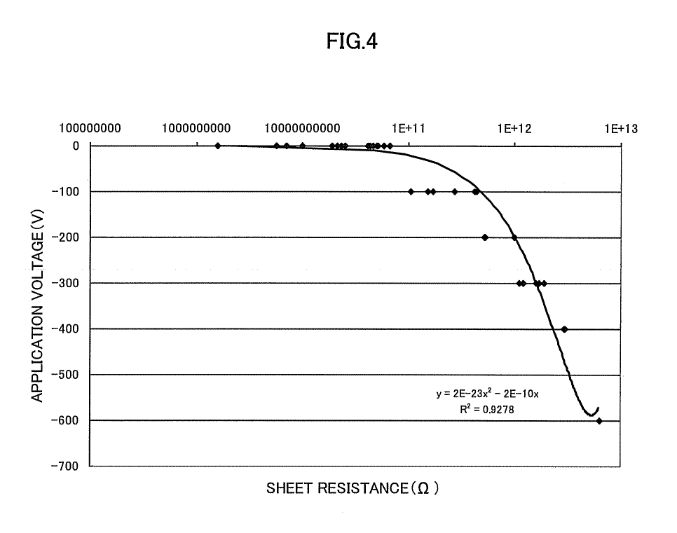

Here, in FIG. 4, a correlation between the resistance values and the application voltages stored in the application voltage table 50 is shown in a graph. The graph shown in FIG. 4 is obtained in the following order. First, images are formed on sheets having various resistance values, and degrees of adsorption of toner onto the fixing belt 20 at that time are examined. Specifically, images of band-like test patterns are formed on front end sides of the sheets in the transport direction, and whether or not figures of the test patterns are shown after regions where the test patterns are formed is examined. This is because, if there is excessive charge on the rear surface of the sheet (the surface on the secondary transfer roller 10 side) and the charge is moved to the fixing belt 20 via the pressurizing roller 22 and positively charges the fixing belt 20, toner that is negatively charged on the surface of the sheet and is not fixed yet is adsorbed onto the fixing belt 20 and after the fixing belt 20 is rotated once (or a plurality of times), the adsorbed toner is adhered and fixed onto the rear end side of the same sheet (in the following description, that toner is adsorbed onto the fixing belt 20 and adhered to the sheet again is also called “re-adhesion of toner”).

In addition, for the resistance value which may cause the re-adhesion of toner to a place where an image is not primarily formed, a voltage to be applied by the voltage applying device 24 is obtained so that the re-adhesion of toner is erased or reduced to be invisible. Specifically, for example, if the resistance value of a sheet is 2×10¹²Ω, various voltages are applied to the pressurizing roller 22 by the voltage applying device 24 so that a voltage capable of sufficiently reduce the re-adhesion of toner is obtained. By measuring such voltage values over a range that can be adopted for the resistances of sheets, the relationship between the resistances of sheets and the application voltages capable of preventing re-adhesion of toner, as shown in FIG. 4, can be obtained.

In addition, in FIG. 4, those indicated by dots represent relationships between resistance values that are actually measured and voltage values that can release the pressurizing roller 22 from being charged as being applied during image formation using sheets having the resistances. One indicated by a straight line represents a relationship between resistance values and voltages to be applied to the pressurizing roller 22 that is obtained to approximate dots obtained by such measurements.

The heating control unit 208 controls a power source or the like connected to the induction heating coil 30 thereby controlling the temperature of the fixing belt 20 using the induction heating coil 30.

The foregoing is the description of the configuration and functions of the image forming apparatus of this embodiment. According to the image forming apparatus 1 of this embodiment, in response to the resistance value of a sheet, a voltage that can suppress excessive change in the pressurizing roller 22 can be applied to the pressurizing roller 22. Accordingly, it can be prevented that the fixing belt 20 to which positive charge is transferred is positively charged and adsorbs toner and the toner is adhered to the sheet again.

In addition, depending on a humidity in the vicinity of the image forming apparatus 1, a moisture content of a sheet, and the like, resistance values vary even in the same sheet, and therefore degrees of adsorption of toner onto the fixing belt 20 and re-adhesion of the toner to the sheet are changed. According to this embodiment, even though the resistance value of a sheet is changed due to a change in humidity and the like, a voltage value corresponding to the change is applied to the pressurizing roller 22, so that the re-adhesion of the toner to the sheet can be reliably prevented.

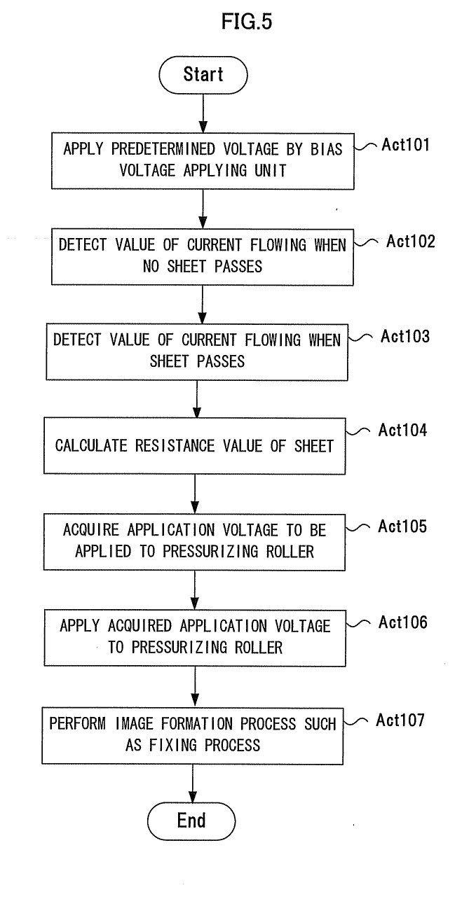

Next, the flow of the image formation process in the image forming apparatus 1 of this embodiment will be described. FIG. 5 is a flowchart showing the flow of the image formation process by the image forming apparatus 1.

First, when a print job or a copy job is generated by a client, the bias voltage application control unit 200 applies a predetermined voltage to the bias voltage application unit 14 (Act 101).

Next, the current value acquisition unit 202 acquires a value of current flowing when no sheet passes by the secondary transfer position T from the current detecting sensor 16 (Act 102). In addition, in Act 102, acquisition of the value of current flowing when no sheet passes may not be performed at this timing, and a value of current that flows as a predetermined bias voltage is applied may be measured in advance.

Next, the current value acquisition unit 202 causes the current detection sensor 16 to measure current flowing when a sheet passes by the secondary transfer position T and acquires a current value (Act 103). Whether or not a sheet passes by the secondary transfer position T may be detected by disposing a sensor or the like that detects the passage of a sheet as described above.

Next, the resistance value calculation unit 204 calculates a resistance value of a sheet which is the object of the image formation process, from the value of current flowing when the sheet passes by the secondary transfer position T and the value of current flowing when no sheet passes, the values being acquired by the current value acquisition unit 202 (Act 104).

Next, the application voltage control unit 206 acquires an application voltage corresponding to the resistance value calculated by the resistance value calculation unit 204 with reference to the application voltage table 50 (Act 105).

In addition, the application voltage control unit 206 causes the voltage application device 24 to apply a voltage corresponding to the acquired voltage value to the pressurizing roller 22 (Act 106) to remove charge from the pressurizing roller 22.

In addition, while the voltage is applied by the voltage application device 24, the image formation process including the fixing process on the sheet by the fixing device is performed (Act 107).

In addition, in Act 103, it is preferable that a voltage applied is calculated after the value of current flowing while the sheet passes by the secondary transfer position T is detected by the current detection sensor 16 until the sheet reaches the pressurizing roller 22, and the calculated voltage may be applied to the pressurizing roller 22. Accordingly, positive charge transferred from the sheet can be reliably removed.

In this embodiment, it is described that the fixing device of the image forming apparatus 1 includes the fixing belt 20, the fixing roller 26 and the tension roller 28 on which the fixing belt 20 is suspended, and the pressurizing roller 22. However, the embodiment is not limited thereto. Instead of the fixing belt 20, a fixing roller may be included. In addition, instead of the pressurizing roller 22, a pressurizing belt suspended on a plurality of rollers may be included. In any case, positive charge is reduced by applying a voltage corresponding to the resistance value of a sheet to the pressurizing roller or the pressurizing belt, so that adsorption of toner onto the fixing belt or the fixing roller and re-adhesion of the adsorbed toner to the sheet can be prevented.

In this embodiment, it is described that a positive voltage is applied to the secondary transfer roller 10 and negatively charged toner is transferred onto the sheet. However, the embodiment is not limited thereto. A negative voltage having the same polarity as that of the charge of the toner may be applied to the secondary transfer opposing roller 12 to repel the toner so that the toner is secondarily transferred onto the sheet from the intermediate transfer belt 8.

In this embodiment, it is described that the current detection sensor 16 that measures current flowing between the secondary transfer roller 10 and the secondary transfer opposing roller 12 is used as the sensor that measures characteristics of a sheet. However, the embodiment is not limited thereto. The voltage applied to the pressurizing roller 22 may be determined by measuring a value that may have a correlation with the resistance value of a sheet. For example, as the thickness of a sheet is increased, the resistance of the sheet is also increased. Therefore, as a media sensor that measures characteristics of a sheet, a sensor that measures the thickness of a sheet is disposed, and a relationship between the thickness and the resistance value of the sheet may be obtained in advance to calculate the resistance value of the sheet from the measured thickness.

In this embodiment, it is described that the resistance value of a sheet is measured from the current flowing between the secondary transfer roller 10 and the secondary transfer opposing roller 12. However, the embodiment is not limited thereto. Any position other than the secondary transfer position T may be applied as long as current flowing through a sheet that is an object of image formation can be measured at the position. For example, a voltage may be applied to the pair of transport rollers 44 which are registration rollers disposed on the upstream side of the sheet transport direction with respect to the secondary transfer position T to measure a value of flowing current. In addition, a pair of rollers dedicated for measuring current may be disposed to apply a voltage thereto and measure the current. In addition, when a voltage is applied, current needs to flow. Therefore, the pair of rollers to which the voltage is applied need to have conductive properties (or semi-conductive properties).

In this embodiment, it is described that the charging brush portion 24b is used as a member that comes in contact with the pressurizing roller 22 of the voltage applying device 24. However, the embodiment is not limited thereto. The member is not limited to a brush-like member, and for example, a member having a shape of a plate spring made of metal having conductive properties or the like may be caused to come in contact with the pressurizing roller 22 to apply a voltage to the pressurizing roller 22.

In this embodiment, the application voltage table 50 in which the resistance values of sheets correspond to voltages to be applied is provided in the image forming apparatus 1. However, the embodiment is not limited thereto. For example, an application voltage table may be stored in an external storage region connected to the image forming apparatus 1 via a network so that the image forming apparatus 1 accesses to the external storage region and acquires voltage values.

According to the embodiments described above in detail, an image forming apparatus with no staining or deterioration of images can be provided.

While certain embodiments have been described, these embodiments have been presented by way of example only, and are not intended to limit the scope of invention. Indeed, the novel apparatus and methods described herein may be embodied in a variety of other forms; furthermore, various omissions, substitutions and changes in the form of the apparatus and methods described herein may be made without departing from the sprit of the inventions. The accompanying claims and their equivalents are intended to cover such forms or modifications as would fall within the scope and spirit of the inventions.

What is claimed is:

1. An image forming apparatus comprising:
an image holding body that transfers toner onto a sheet;
a transfer voltage applying unit that applies a transfer voltage for transferring the toner onto the sheet from the image holding body;
a fixing unit that includes a heating rotation body which heats the toner on the sheet to fix the toner onto the sheet, and a pressurizing body which forms a nip portion with the heating rotation body and nips and transports the sheet by cooperating with the heating rotation body;
a sensor unit that is at a position on an upstream side of the fixing unit in a sheet transport direction and detects an electrical resistance value of the sheet; and
a voltage applying unit that applies a predetermined voltage value having the opposite polarity to that of a voltage applied by the transfer voltage applying unit to a reverse surface to a toner transfer surface of the sheet, to the pressurizing body, on the basis of the electrical resistance value of the sheet detected by the sensor unit.

2. The apparatus according to claim 1, wherein the sensor unit detects the electrical resistance value of the sheet on the basis of a value of current flowing from one surface of the sheet to the other surface of the sheet when a voltage is applied to both the surfaces of the sheet.

3. The apparatus according to claim 2, wherein the sensor unit detects the electrical resistance value of the sheet on the basis of the value of current flowing through the sheet as the transfer voltage is applied by the transfer voltage applying unit.

4. The apparatus according to claim 3, further comprising a transfer member that is disposed to oppose the image holding body and comes in pressing contact with the image holding body,
wherein the transfer voltage applying unit applies the transfer voltage between the image holding body and the transfer member.

5. The apparatus according to claim 2, wherein the sensor unit detects the electrical resistance value of the sheet on the basis of the value of current flowing through the sheet as a voltage is applied to a pair of transport rollers disposed on the upstream side of the fixing unit in the sheet transport direction.

6. The apparatus according to claim 1, wherein the sensor unit detects a thickness of the sheet and calculates the electrical resistance value of the sheet on the basis of the detected thickness of the sheet.

7. The apparatus according to claim 1, wherein the voltage applying unit acquires, from a predetermined storage region which stores in advance a data table in which the predetermined voltage value corresponds to the electrical resistance value, the predetermined voltage value.

8. The apparatus according to claim 1, wherein the voltage applying unit applies a voltage using a brush which comes in contact with the pressurizing body and has conductive properties.

9. The apparatus according to claim 1, wherein the voltage applying unit applies a voltage using a plate spring member which comes in contact with the pressurizing body and has conductive properties.

10. An image formation processing method in an image forming apparatus which includes an image holding body that transfers toner onto a sheet, a transfer voltage applying unit that applies a transfer voltage for transferring the toner onto the sheet from the image holding body, and a fixing unit that includes a heating rotation body which heats the toner on the sheet to fix the toner onto the sheet and a pressurizing body which forms a nip portion with the heating rotation body and nips and transports the sheet by cooperating with the heating rotation body, the method comprising:
detecting an electrical resistance value of the sheet at a position on an upstream side of the fixing unit in a sheet transport direction; and
applying a predetermined voltage value having the opposite polarity to that of a voltage applied by the transfer voltage applying unit to a reverse surface to a toner transfer surface of the sheet, to the pressurizing body, on the basis of the detected electrical resistance value of the sheet.

11. The method according to claim 10, wherein the electrical resistance value of the sheet is detected on the basis of a value of current flowing from one surface of the sheet to the other surface of the sheet when a voltage is applied to both the surfaces of the sheet.

12. The method according to claim 11, wherein the electrical resistance value of the sheet is detected on the basis of the value of current flowing through the sheet as the transfer voltage is applied by the transfer voltage applying unit.

13. The method according to claim 12,
wherein the image forming apparatus further includes a transfer member that is disposed to oppose the image holding body and comes in pressing contact with the image holding body, and
the transfer voltage applying unit applies the transfer voltage between the image holding body and the transfer member.

14. The method according to claim 11, wherein the electrical resistance value of the sheet is detected on the basis of the value of current flowing through the sheet as a voltage is applied to a pair of transport rollers disposed on the upstream side of the fixing unit in the sheet transport direction.

15. The method according to claim 10, wherein a thickness of the sheet is detected and the electrical resistance value of the sheet is calculated on the basis of the detected thickness of the sheet.

16. The method according to claim 10, wherein, from a predetermined storage region which stores in advance a data table in which the predetermined voltage value corresponds to the electrical resistance value, the predetermined voltage value is acquired.

17. The method according to claim 10, wherein the voltage applying unit applies a voltage using a brush which comes in contact with the pressurizing body and has conductive properties.

18. The method according to claim 10, wherein the voltage applying unit applies a voltage using a plate spring member which comes in contact with the pressurizing body and has conductive properties.
